(19) United States
(12) Patent Application Publication
(10) Pub. No.: US 2009/0179820 A1
(43) Pub. Date: Jul. 16, 2009

(54) Antenna System

(76) Inventor: Bert Jannsen, Hildesheim (DE)

Correspondence Address: KENYON & KENYON LLP, ONE BROADWAY, NEW YORK, NY, 10004, US

(21) Appl. No.: 12/086,801

(22) PCT Filed: Nov. 20, 2006
(86) PCT No.: PCT/EP2006/068653

§ 371 Date: Dec. 8, 2008

(30) Foreign Application Priority Data
Dec. 23, 2005 (DE) 102005061864.2

(51) Int. Cl. H01Q 1/12; H01Q 1/36; H01Q 3/01

(52) U.S. Cl. 343/878; 343/700 MS; 343/880

(57) ABSTRACT

Provided in an antenna system is an antenna element which is mounted in front of a conductive surface. At least one shape parameter of the spacer between the antenna element and the conductive surface and at least one shape parameter of the conductive surface are taken into account for adjusting the antenna beam characteristics.

### BACKGROUND INFORMATION

Antennas which may be simply and compactly designed are advantageous in particular for the reception of satellite services such as SDARS or GPS. In addition, it must be possible to adjust the beam characteristics, i.e., the antenna diagram, to the requirements of the various services. As a rule, patch antennas are currently used which may be manufactured compactly and economically, and which are also able to provide the polarization (left/right-hand circular) required for the satellite services. However, for these antennas there is only a limited capability for adjusting the antenna diagram (gain as a function of the elevation angle and azimuth angle).

An antenna system having such a patch antenna element is described in PCT International Patent Publication No. WO 02/43183 which is situated at a distance in front of a conductive surface. In the cited document measures are provided for accurately and reproducibly fixing the patch antenna element in position with respect to the conductive surface.

European Patent No. EP 0716470 describes a similar structure having a patch antenna element situated at a distance from a conductive surface. Dielectric components are incorporated into the conductive surface for suppression of components of the radiation in the backward direction.

European Patent No. EP 901185 describes a patch antenna element and a conductive surface situated at a distance, and discloses measures for suppression of polarization rotations.

### SUMMARY OF THE INVENTION

According to the present invention, taking into account at least one shape parameter of the spacer between the antenna element and the conductive surface and at least one shape parameter of the conductive surface for adjustment of the antenna beam characteristics, a required antenna beam characteristic may be easily adjusted without the need for specialized, complicated additional measures such as slotted structures in the conductive surface, incorporation of dielectric materials, etc.

Different beam characteristics for various services possibly requiring polarization may be adjusted solely by influencing the shape of the spacer for the antenna element, which is necessary anyway, in relation to the shape and size of the conductive surface. The contour of the beam characteristic may be influenced solely via the height of the spacer and/or the extension of the conductive surface, or its radius when the surface has a circular design. Thus, for example, independently from these two shape parameters, the gain outside the center of the antenna element may be adjusted in such a way that, in addition to the reception of circularly polarized waves, vertically polarized waves, in particular for low elevation angles, may be received at an alternate signal strength. Other shape parameters/degrees of freedom for influencing the antenna beam characteristics for the spacer are the height of the webs, the size of the openings separated from one another by the webs, or edges which reduce the height and/or width of the openings.

For the antenna systems according to the publications cited above, no measures are discernible for influencing in a targeted manner the antenna beam characteristics on the basis of a shape parameter of the conductive surface and a shape parameter of the spacer for the antenna element with respect to the conductive surface.

### BRIEF DESCRIPTION OF THE DRAWINGS

FIG. 1 shows the design of the antenna system according to the present invention.

FIG. 2 shows the antenna gain as a function of the radius of a circular conductive surface, with the spacer dimensions constant.

FIG. 3 shows the antenna gain as a function of the height of the spacer, with a constant radius of the circular conductive surface and otherwise constant dimensions of the spacer.

### DETAILED DESCRIPTION

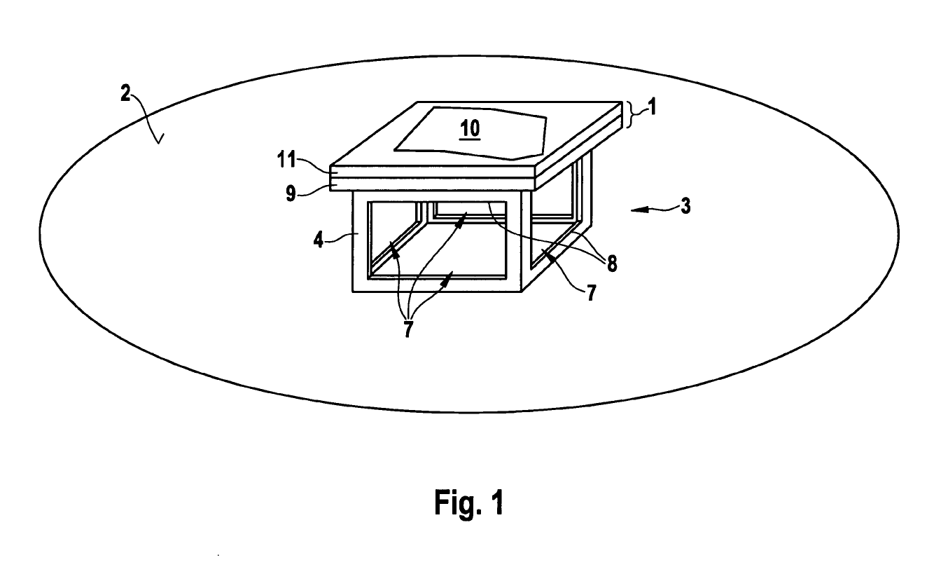

The present invention is based on the finding that an existing antenna element 1, for example a patch antenna element, in combination with a support 9, a metallic coating 10, and a dielectric 11 may be influenced by varying the surroundings thereof, i.e., shape parameters such as attachments and surface parameters, in such a way that the antenna beam characteristics may be adjusted over wide ranges. This concept is schematically illustrated in FIG. 1. Adjustment possibilities are at least one shape parameter of conductive surface 2 in combination with a shape parameter of spacer 3 between conductive surface 2 and antenna element 1. Spacer 3, which in FIG. 1 is illustrated in the form of a square having openings 7 and associated edges 8 and webs 4, may have various designs. The present invention is based on the fact that the antenna beam characteristics may be influenced by the dimensioning of openings 7, webs 4, and edges 8, as well as the shape and size of conductive surface 2.

The influences are described as follows.

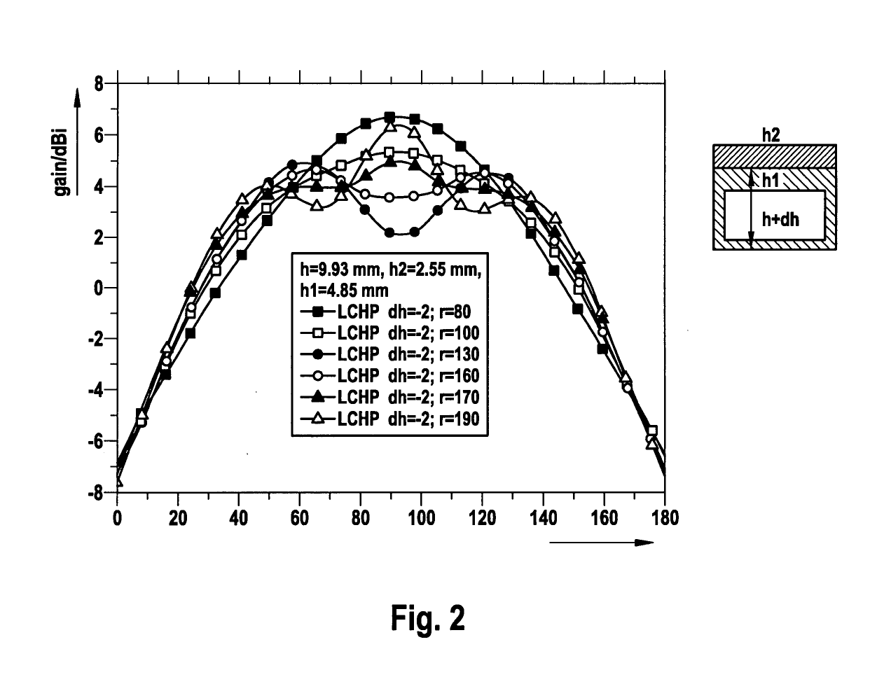

1. Base surface (conductive surface 2): the base surface may be used for influencing the antenna beam characteristics. The base surface is preferably designed as a circular disk. FIG. 2 shows as an example the left-hand circularly polarized (LHCP) gain (gain/dBi) as a function of the elevation angle at an azimuth of 0° for varying shape parameter radius r of a circular base surface. Other base surfaces which are asymmetrical may also be used. Heights h1 and h2 take into account the actual distance of metal coating 10 of patch element 1 from conductive surface 2, since in addition to height h+dh of spacer 3, the thickness of dielectric 11 and of support 9 also play a role.

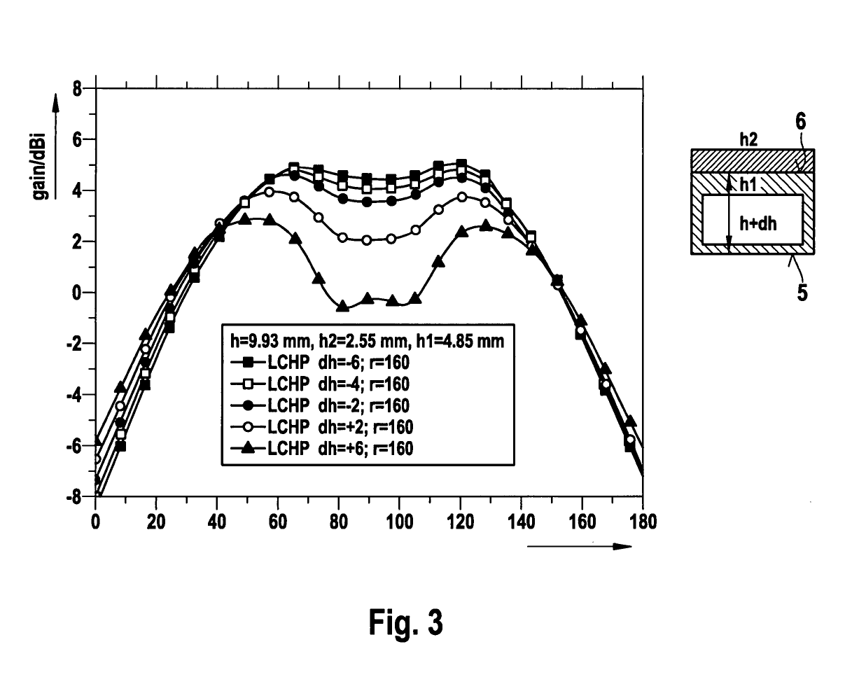

2. FIG. 3 shows the gain (gain/dBi) as a function of the elevation angle at an azimuth of 0° for the varying shape parameter of the height of the antenna holder h+dh for a constant circular base surface and otherwise constant dimensions of spacer 3. The following additional shape parameters may also be taken into account as shape parameters of spacer 3 having webs 4 between a base surface 5 and a top surface 6: height of webs 4, size of openings 7 separated from one another by webs 4, and edges 8 which reduce the height and/or width of openings 7. In FIG. 3, dh varies between −6 mm and +6 mm relative to starting height=9.93 mm, whereas radius r=160 mm is selected to be constant.

It is apparent from FIGS. 2 and 3 that by using the present invention the shape parameters may be adjusted in such a way that the antenna gain outside the center of patch element 1 is greater than in the center. This allows a broader antenna beam characteristic to be achieved, and/or allows an antenna beam characteristic to be achieved for other applications, for example in the form of vertically polarized waves, in particular for low elevation angles.

1-8. (canceled)

9. An antenna system comprising:
a conductive surface;
an antenna element mounted in front of the conductive surface at a distance; and
a spacer between the antenna element and the conductive surface,
wherein at least one shape parameter of the spacer and at least one shape parameter of the conductive surface are taken into account for adjusting antenna beam characteristics.

10. The antenna system according to claim 9, wherein for a predefined shape parameter of the conductive surface, a shape parameter of the spacer is adjusted in such a way that a predefined antenna beam characteristic results.

11. The antenna system according to claim 10, wherein the conductive surface is a circular disk, the shape parameter of the conductive surface is a radius, and the shape parameter of the spacer is a height of the spacer.

12. The antenna system according to claim 9, wherein for a specified shape parameter of the spacer, a shape parameter of the conductive surface is adjusted in such a way that a predefined antenna beam characteristic results.

13. The antenna system according to claim 12, wherein the shape parameter of the spacer is a height of the spacer, the conductive surface is a circular disk, and the shape parameter of the conductive surface is a radius.

14. The antenna system according to claim 9, wherein the spacer has webs between a base surface and a top surface, at least one of the following variables being taken into account as a shape parameter: a height of the webs, a size of openings separated from one another by the webs, and edges which reduce at least one of the height and width of the openings.

15. The antenna system according to claim 9, wherein the antenna element is a patch antenna element.

16. The antenna system according to claim 9, wherein the antenna system is used for adjusting an antenna gain as a function of at least one of an elevation angle and an azimuth angle.

17. The antenna system according to claim 9, wherein the antenna system is used for satellite services having circular polarization.

18. The antenna system according to claim 9, wherein the antenna system is used using an adjustment of the shape parameters in such a way that an antenna gain outside a center of the antenna element is greater than in the center.
